(19) United States
(12) Patent Application Publication
(10) Pub. No.: US 2007/0072467 A1
(43) Pub. Date: Mar. 29, 2007

(54) Method of testing a substrate and apparatus for performing the same

(75) Inventors: Young-Soo Lee, Seongnam-si (KR); Dong-Chun Lee, Cheonan-si (KR); Seong-Chan Han, Cheonan-si (KR); Hyo-Jae Bang, Cheonan-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/525,971

(22) Filed: Sep. 25, 2006

(30) Foreign Application Priority Data
Sep. 26, 2005 (KR) 2005-89252

(51) Int. Cl. H01R 29/00

(52) U.S. Cl. 439/189

(57) ABSTRACT

A method of testing a substrate may involve photographing a first chip on a first face of the substrate to obtain a first image of the first chip, and photographing a second chip on a second face of the substrate opposite to the first face without reversing the substrate to obtain a second image of the second chip. The normality of the first and the second chips may be determined based on the first and the second images.

### PRIORITY STATEMENT

This application claims priority under 35 USC § 119 from Korean Patent Application No. 2005-89252, filed on Sep. 26, 2005, the contents of which are herein incorporated by reference in its entirety.

### BACKGROUND

1. Field of the Invention

Example embodiments of the present invention relate to a method of testing a substrate (e.g., a printed circuit board) and an apparatus for performing the same. More particularly, example embodiments of the present invention relate to a method of testing appearances of chips (for example) that may be mounted on the substrate, and an apparatus for performing the method.

2. Description of the Related Art

Memory modules may be implemented in a computer to which semiconductor devices may be applied. The memory modules may include a substrate (such as a printed circuit board (PCB), for example) on which a plurality of semiconductor chips (which may serve as unit memory devices, for example) may be mounted.

The semiconductor chips may be mounted on only one face of a conventional PCB. However, to increase a memory capacity of the PCB, the semiconductor chips may be mounted on both faces of the PCB. After the semiconductor chips are mounted on the both faces of the PCB, a testing process for the PCB may be carried out to examine whether the semiconductor chips are accurately mounted on the PCB.

FIG. 1 is a block diagram of a conventional apparatus for testing a PCB.

Referring to FIG. 1, a conventional apparatus 10 for testing a PCB may include a loading unit 2, a first testing unit 3, a reversing unit 4, a second testing unit 5 and an unloading unit 6.

The loading unit 2 may load the PCB (having semiconductor chips mounted on both faces) into the first testing unit 3. The first testing unit 3 may include an image-obtaining unit (not shown) that may obtain an image of a first semiconductor chip on a first face of the PCB, and an inspecting unit that may inspect the first semiconductor chip based on the image of the first semiconductor chip that is obtained from the image-obtaining unit.

To inspect a second semiconductor chip on a second face of the PCB (which may be opposite to the first face), the reversing unit 4 may reverse the PCB at an angle of about 180°. The reversed PCB may be loaded into the second testing unit 5. The second testing unit 5 may include elements substantially the same as those of the first testing unit 3. The second testing unit 5 may examine the second semiconductor chip. Alternatively, the reversed PCB may be reloaded into the first testing unit 3 without using the second testing unit 5. The first testing unit 3 may inspect the second semiconductor chip.

After the first semiconductor chip on the first faces of the PCB and the second semiconductor chip on the second face of the PCB are tested, the unloading unit 6 may unload the PCB.

According to conventional wisdom, the reversing unit 4 may reverse the PCB so that opposed faces thereof may be tested.

Because the conventional apparatus 10 may include two testing units and the reversing unit, the conventional apparatus 10 may have a complicated structure. Further, the complicated structure of the conventional apparatus 10 may cause complicated processes for testing the PCB. As a result, a conventional method of testing the PCB using the conventional apparatus may have poor testing efficiency.

### SUMMARY

According to an example, non-limiting embodiment, a method may involve photographing a first chip on a first face of a substrate to obtain a first image of the first chip, and photographing a second chip on a second face of the substrate, which is opposite to the first face, without reversing the substrate to obtain a second image of the second chip. The normality of the first and the second chips may be determined based on the first and the second images.

According to another example, non-limiting embodiment, an apparatus may include a first image-obtaining unit to obtain a first image of a first chip that may be mounted on a first face of a substrate. A second image-obtaining unit may be provided to obtain a second image of a second chip that may be mounted on a second face of the substrate opposite to the first face. A testing unit may be provided to examine the first and the second chips based on the first and the second images.

### BRIEF DESCRIPTION OF THE DRAWINGS

Example, non-limiting embodiments of the invention will be described with reference to the accompanying drawings.

FIG. 1 is a block diagram of a conventional apparatus for testing a PCB.

FIG. 2 is a block diagram of an apparatus for testing a PCB in accordance an example, non-limiting embodiment of the present invention.

FIG. 3 is a schematic diagram of an image-obtaining unit and a testing unit that may be implemented in the apparatus of FIG. 2.

FIG. 4 is a flow chart of a method of testing a PCB that may be performed by the apparatus in FIGS. 2 and 3.

### DESCRIPTION OF EXAMPLE, NON-LIMITING EMBODIMENTS

Example, non-limiting embodiments of the present invention are described with reference to the accompanying drawings. This invention may, however, be embodied in many different forms and should not be construed as limited to the example embodiments set forth herein. Rather, the disclosed embodiments are provided so that this disclosure will be thorough and complete, and will fully convey the scope of the invention to those skilled in the art. In the drawings, the size and relative sizes of layers and regions may be exaggerated for clarity. The drawings are not to scale. Like reference numerals refer to like elements throughout.

It will be understood that when an element or layer is referred to as being “on,” “connected to” and/or “coupled to” another element or layer, it can be directly on, connected and/or coupled to the other element or layer or intervening elements or layers may be present. In contrast, when an element is referred to as being “directly on,” “directly connected to” and/or “directly coupled to” another element or layer, there are no intervening elements or layers present. As used herein, the term “and/or” includes any and all combinations of one or more of the associated listed items.

Although the terms first, second, etc. may be used to describe various elements, components, regions, layers and/or sections, these elements, components, regions, layers and/or sections should not be limited by these terms. The terms may be used to distinguish one element, component, region, layer or section from another element, component region, layer or section. For example, a first element, component, region, layer and/or section discussed below could be termed a second element, component, region, layer and/or section without departing from the teachings of the present invention.

Spatially relative terms, such as “beneath,” “below,” “lower,” “above,” “upper” and the like, may be used for ease of description to describe one element and/or feature's relationship to another element(s) and/or feature(s), for example, as illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements and/or features would then be oriented “above” the other elements and/or features. The device may be otherwise oriented (rotated 90 degrees or at other orientations) and the spatially relative descriptors used herein interpreted accordingly.

The terminology used herein is for the purpose of describing example embodiments only and is not intended to be limiting of the invention. As used herein, the singular terms “a,” “an” and “the” are intended to include the plural forms as well, unless the context clearly indicates otherwise. It will be understood that the terms “includes” and/or “including” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein may have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized and/or overly formal sense unless expressly so defined herein.

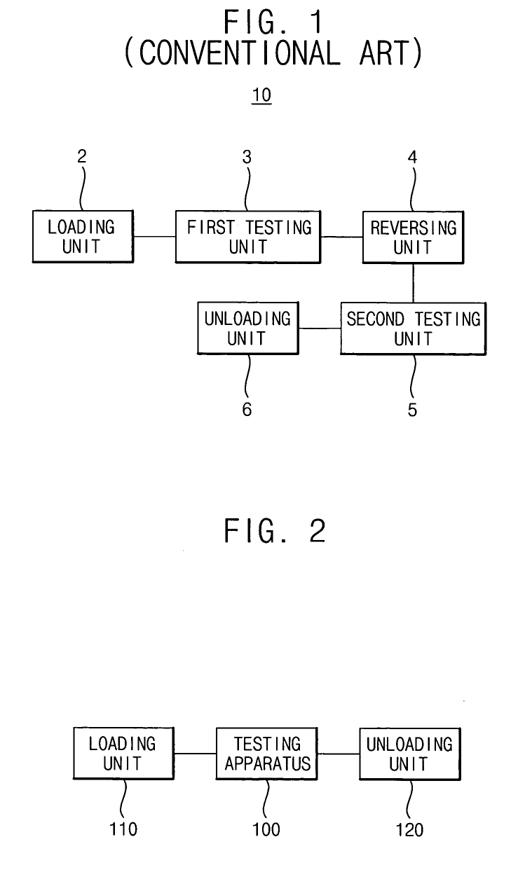

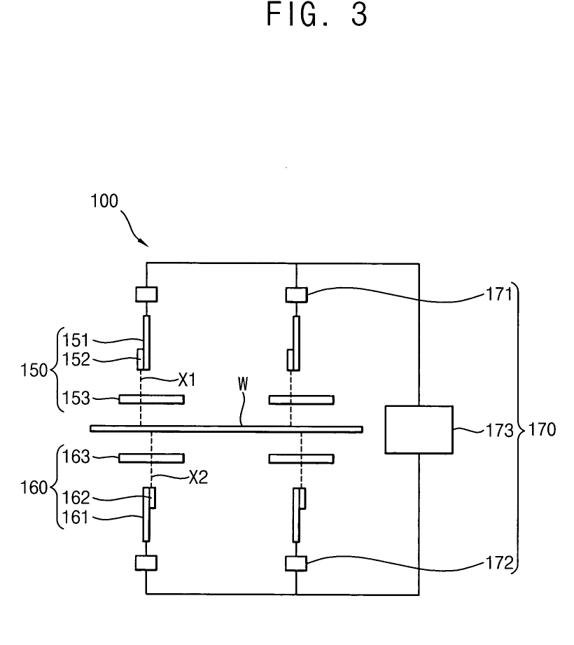

FIG. 2 is a block diagram of an apparatus for testing a substrate (e.g., a PCB) in accordance with an example non-limiting embodiment of the present invention, and FIG. 3 is a schematic diagram of an image-obtaining unit and a testing unit that may be implemented in FIG. 2.

Referring to FIG. 2, an apparatus 100 for testing a PCB may be arranged between a loading unit 110 and an unloading unit 120. The loading unit 110 may load an object (such as the PCB for a semiconductor module having both faces on which semiconductor chips are mounted, for example) into the testing apparatus 100. The unloading unit 120 may unload the PCB from the testing apparatus 100. The testing apparatus 100 may test the first and the second semiconductor chips on both faces of the PCB. Thus, a conventional reversing unit for reversing the PCB may not be employed in the testing apparatus 100. In this example embodiment, testing on opposed sides of the PCB may be carried out simultaneously. In alternative embodiments, testing on opposed sides may be carried out sequentially.

Referring to FIG. 3, the testing apparatus 100 may include a first image-obtaining unit 150 to obtain a first image of the first semiconductor chip that may be mounted on a first face of the PCB W, a second image-obtaining unit 160 to obtain a second image of a second semiconductor chip that may be mounted on a second face of the PCB W that is opposite to the first face, and a testing unit 170 to examine the first and the second semiconductor chips based on the first and the second images obtained from the first and the second image-obtaining units 150 and 160. In FIG. 3, a first face of the PCB W may correspond to an upper face of the PCB W. A second face of the PCB W may correspond to a lower face of the PCB W. The first image-obtaining unit 150 may be positioned over the PCB W. The second image-obtaining unit 160 may be positioned under the PCB W. It will be appreciated that more than one semiconductor chip may be provided on each of the first and the second surfaces of the PCB. In alternative embodiments, the PCB may have only one surface provided with one or more semiconductor chips.

The first image-obtaining unit 150 may include a first camera 151 to photograph the first semiconductor chip. A first illuminator 152 may be arranged adjacent to the first camera 151 to irradiate a first light onto the first semiconductor chip. A first lens 153 may be arranged between the first camera 151 and the PCB W to receive the first image information with respect to the first semiconductor chip illuminated with the first light. By way of example only, the first camera 151 may include a charge coupled device (CCD) camera, and the first light emitted from the first illuminator 152 may be a linear light. It will be appreciated that numerous and varied cameras and illuminators may be suitably implemented.

The second image-obtaining unit 160 may include a second camera 161 to photograph the second semiconductor chip. A second illuminator 162 may be arranged adjacent to the second camera 161 to irradiate a second light onto the second semiconductor chip. A second lens 163 may be arranged between the second camera 161 and the PCB W to receive the first image information with respect to the second semiconductor chip illuminated with the second light. By way of example only, the second camera 161 may include a charge coupled device (CCD) camera, and the second light emitted from the second illuminator 162 may be a linear light. It will be appreciated that numerous and varied cameras and illuminators may be suitably implemented.

The first light emitted from the first illuminator 152 may have a first optical axis X1. The second light emitted from the second illuminator 162 may have a second optical axis X2. The first and the second lights may be substantially perpendicular to the first and the second faces of the PCB W, respectively. Therefore, the first and the second optical axes X1 and X2 may be substantially perpendicular to the first and the second faces of the PCB W.

A plurality of holes may be formed through the PCB W. When the first and the second optical axes X1 and X2 are arranged on the same straight line, the first light may be irradiated to a lower space under the PCB W through the holes or the second light may be irradiated to an upper space over the PCB W through the holes. As a result, the first and the second lights may interfere with each other so that the first and the second cameras 151 and 161 may not accurately photograph the first and the second semiconductor chips. And the first and the second image-obtaining units 150 and 160 may not obtain the desired first and the desired second images.

In view of the above, the first and the second illuminators 152 and 162 may be offset from each other. Thus, the first optical axis X1 of the first light and the second optical axis X2 of the second light may be substantially parallel to each other and not positioned on the same straight line. That is, the first and the second illuminators 152 and 162 may be alternately arranged to offset the second optical axis X2 from the first optical axis X1.

In this example embodiment, the number of each of the first and the second image-obtaining units 150 and 160 may be two. Alternatively, the number of the first and the second image-obtaining units 150 and 160 may be varied in accordance with a size of the PCB W.

The testing unit 170 may include a first sub-controller 171 to control the first image-obtaining unit 150, a second sub-controller 172 to control the second image-obtaining unit 160, and a main controller 173 to determine the normality of the first and the second semiconductor chips based on the first and the second images.

The first sub-controller 171 may control the first camera 151, the first illuminator 152 and the first lens 153. The first sub-controller 171 may receive the first image information with respect to the first semiconductor chip photographed with the first camera 151.

The second sub-controller 172 may control the second camera 161, the second illuminator 162 and the second lens 163. The second sub-controller 172 may receive the second image information with respect to the second semiconductor chip photographed with the second camera 152.

The main controller 173 may receive the first and the second image information with respect to the first and the second semiconductor chips, respectively, from the first and the second sub-controllers 171 and 172. The main controller 173 may process the first and the second image information to create the first and the second images. The main controller 173 may determine the normality of the first and the second semiconductor chips based on the first and the second images.

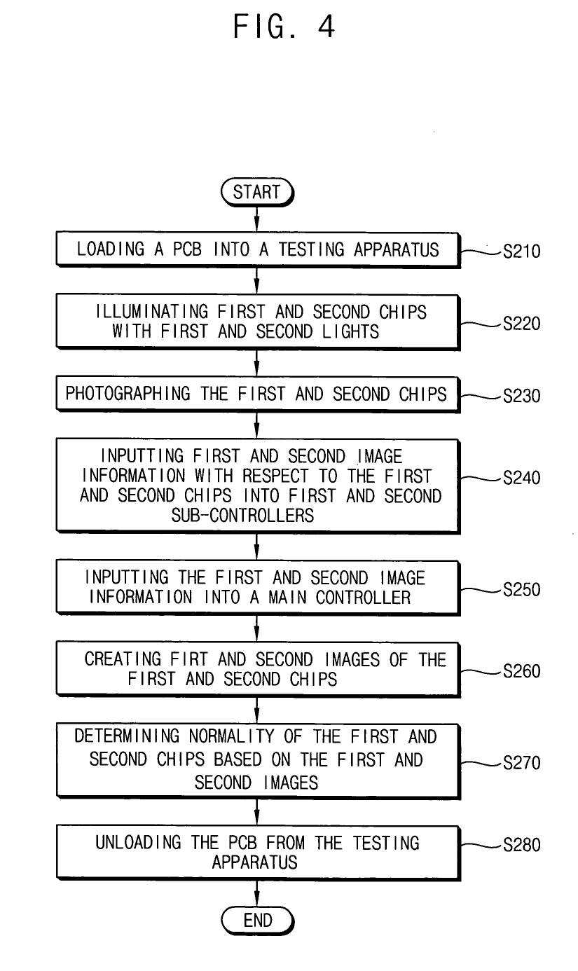

FIG. 4 is a flow chart of a method of testing a PCB that may be performed by the apparatus 100 in FIGS. 2 and 3.

Referring to FIGS. 2 to 4, at S210, the loading unit 110 may load the PCB W into the testing apparatus 100. The PCB W may be arranged between the first and the second image-obtaining units 150 and 160.

At S220, the first illuminator 152 may irradiate the first light onto the first semiconductor chip to illuminate the first semiconductor chip. The second illuminator 162 may irradiate the second light onto the second semiconductor chip to illuminate the second semiconductor chip. Because the first and the second lights are substantially parallel with each other and offset from each other, the first and the second lights may not interfere with each other. The first illuminator 152 and the second illuminator 162 may illuminate the semiconductor chips simultaneously, or sequentially.

At S230, the first camera 151 may photograph the first semiconductor chip illuminated with the first light. The second camera 152 may photograph the second semiconductor chip illuminated with the second light. The first camera 151 and the second camera 152 may photograph the semiconductor chips simultaneously, or sequentially.

At S240, the first image information with respect to the first semiconductor chip photographed with the first camera 151 may be inputted into the first sub-controller 171, and the second image information with respect to the second semiconductor chip photographed with the second camera 161 may be inputted into the second sub-controller 172.

At S250, the first and the second image information may be inputted into the main controller 173.

At S260, the main controller 173 may process the first and the second image information to create the first and the second images with respect to the first and the second semiconductor chips, respectively.

At S270, the main controller 173 may determine the normality of the first and the second semiconductor chips based on the first and the second images.

At S280, the unloading unit 120 may unload the PCB W from the testing apparatus 100.

In this example embodiment, the PCB supporting semiconductor chips may be tested. Alternatively, the apparatus and the method in accordance with example embodiments of the present invention may be employed to test other substrates (besides PCB's), which support other electronic parts (besides semiconductor chips).

According to example embodiments of the present invention, the semiconductor chips on both faces of the PCB may be tested without reversing the PCB. Thus, a reversing unit for reversing the PCB may not needed. Therefore, as compared to a conventional apparatus, the disclosed apparatus may have a simple structure.

Because the disclosed method may not include a process for reversing the PCB, the method of testing the PCB may be simplified (as compared to conventional techniques). As a result, the method and the apparatus in accordance with example embodiments of the present invention may have improved testing efficiency.

Having described example, non-limiting embodiments of the present invention, numerous and varied modifications and variations may become apparent to those skilled in the art. It will be understood that changes may be suitably implemented in the disclosed embodiments, and that such changes still fall within the spirit and scope of the invention as defined by the appended claims.

What is claimed is:

1. A method of testing a substrate, comprising:
photographing a first chip on a first face of the substrate to obtain a first image of the first chip;
photographing a second chip on a second face of the substrate, which is opposite to the first face, without reversing the substrate to obtain a second image of the second chip; and
determining the normality of the first and the second chips based on the first and the second images.

2. The method of claim 1, wherein photographing the first chip is carried out simultaneously with photographing the second chip.

3. The method of claim 1, wherein photographing the first chip further comprises illuminating the first chip with a first light, and photographing the second chip further comprises illuminating the second chip with a second light.

4. The method of claim 3, wherein the first light has a first optical axis substantially perpendicular to the first and the second faces, and the second light has a second optical axis substantially in parallel to and offset from the first optical axis.

5. The method of claim 3, wherein the first and the second lights have a linear shape.

6. The method of claims 1, wherein the substrate is a board for a semiconductor memory module.

7. An apparatus for testing a substrate, comprising:
a first image-obtaining unit to obtain a first image of a first chip that is mounted on a first face of the substrate;
a second image-obtaining unit to obtain a second image of a second chip that is mounted on a second face of the substrate opposite to the first face; and
a testing unit to examine the first and the second chips based on the first and the second images.

8. The apparatus of claim 7, wherein the first image-obtaining unit is arranged substantially perpendicular to the first face of the substrate, and the second image-obtaining unit is arranged substantially in parallel to and offset from the first image-obtaining unit.

9. The apparatus of claim 7, wherein the first image-obtaining unit comprises:
a first camera for photographing the first chip;
a first illuminator positioned adjacent to the first camera to irradiate a first light onto the first chip; and
a first lens arranged between the first camera and the first face of the substrate to receive the first image information with respect to the first chip illuminated with the first light.

10. The apparatus of claim 9, wherein the first camera comprises a charge coupled device camera.

11. The apparatus of claim 9, wherein the first light is substantially perpendicular to the first face of the substrate.

12. The apparatus of claim 9, wherein the first light has a linear shape.

13. The apparatus of claim 7, wherein the second image-obtaining unit comprises:
a second camera for photographing the second chip;
a second illuminator positioned adjacent to the second camera to irradiate a second light onto the second chip; and
a second lens arranged between the second camera and the second face of the substrate to receive the second image information with respect to the second chip illuminated with the second light.

14. The apparatus of claim 13, wherein the second camera comprises a charge coupled device camera.

15. The apparatus of claim 13, wherein the second light is substantially perpendicular to the second face of the substrate.

16. The apparatus of claim 13, wherein the second light has a linear shape.

17. The apparatus of claims 7, wherein the substrate is a board for a semiconductor memory module.

18. The apparatus of claim 7, wherein the first image-obtaining unit is positioned over the first face of the substrate; and
wherein the second image-obtaining unit is positioned under the second face of the substrate.

19. The apparatus of claim 18, wherein the first image-obtaining unit is arranged substantially perpendicular to the first face of the substrate, and the second image-obtaining unit is arranged substantially in parallel to and offset from the first image-obtaining unit.

20. The apparatus of claim 7, wherein the substrate is a printed circuit board.
